(19) United States
(12) Patent Application Publication
(10) Pub. No.: US 2016/0233736 A1
(43) Pub. Date: Aug. 11, 2016

(54) THREE-DIMENSIONALLY CONTOURED, ACOUSTICALLY EFFECTIVE HEAT SHIELD FOR A MOTOR VEHICLE AND METHOD FOR THE PRODUCTION THEREOF

(71) Applicant: Carcoustics TechConsult GmbH, Leverkusen (DE)

(72) Inventors: Christoph Nachbaur, Fraxern (AT); Christian Fink, Dornbirn (AT)

(21) Appl. No.: 14/995,900

(22) Filed: Jan. 14, 2016

(30) Foreign Application Priority Data
Feb. 11, 2015 (DE) 10 2015 101 945.0

(51) Int. Cl. H02K 5/18; B23P 15/26

(52) U.S. Cl. CPC H02K 5/18; B23P 15/26

(57) ABSTRACT

A three-dimensionally contoured, acoustically effective heat shield for a motor vehicle, includes a heat reflection layer made of a metallic material, such as aluminum, and an acoustic insulation layer made of a thermoformable, rubber-elastic and thermoplastic material, and a hot-melt adhesive film made of a polymer material. The adhesive film is disposed between the heat reflection layer and the insulation layer and forms a plane mechanical connection between the heat reflection layer and the insulation layer. A method for producing the three-dimensionally contoured, acoustically effective heat shield includes the steps of providing a two-dimensionally extending material composite and thermoforming the composite in a thermoforming tool, in which at least one mold half has a molding tool temperature that is above the activation temperature of the heat-activatable adhesive film and above the melting temperature of the rubber-elastic material of the insulation layer.

### TECHNICAL FIELD

The subject matter of the present disclosure is a three-dimensionally contoured, acoustically effective heat shield for a motor vehicle, in particular a heat shield for use on the exhaust line or the transmission tunnel of a motor vehicle with an internal combustion engine. Furthermore, a subject matter of the present disclosure is a method for producing a three-dimensionally contoured, acoustically effective heat shield for a motor vehicle.

### BACKGROUND

Because of the high temperatures that occur particularly on the exhaust line of a motor vehicle with an internal combustion engine, which may be 180° and above, the use of heat shields built entirely from metallic components has proved especially useful. These heat shields provide effective thermal shielding and withstand the high temperatures occurring during the operation of the motor vehicle without any problems, even over the entire life of the motor vehicle. It was found, however, that heat shields built entirely from metallic components are increasingly reaching the limits of their capacity in view of the increasingly stricter national regulations regarding noise emission.

The three-dimensionally contoured, acoustically effective heat shields for motor vehicles known from EP 0 881 423 A1 exhibit an improved acoustic efficiency. This document discloses an acoustically effective heat shield which combines a metallic shielding plate with a sound absorption layer, e.g. made of a nonwoven fabric, mounted on a carrier. In this case, the carrier is separated from the shielding plate by an air gap.

A heat shield for a motor vehicle based on a plurality of micro-perforated metal foils, which are connected to each other by means of an adhesive layer and which are furthermore provided with a knob-like embossing, is also apparent from WO 2005/061280 A1. The interconnected metal foils form a self-supporting composite. Furthermore, a sound absorbing layer of a non-woven material is provided.

However, both of the above-mentioned heat shields have a multi-part mechanical construction and therefore require much effort with regard to their production.

### SUMMARY

The present disclosure provides a three-dimensionally contoured acoustically effective heat shield for a motor vehicle with a simplified mechanical configuration. The present disclosure further provides an advantageous method for producing a three-dimensionally contoured, acoustically effective heat shield with a simplified mechanical configuration.

A heat shield according to the disclosure has a three-dimensional contour and is both thermally and acoustically effective. It is intended for use on a motor vehicle, in particular on the exhaust line of a motor vehicle with an internal combustion engine or on the transmission tunnel of such a motor vehicle. It has a heat reflection layer made of a metallic material, such as aluminum, and an acoustic insulation layer made of a thermoplastic, rubber-elastic and thermoformable material having a density between 1 g/ccm and 5 g/ccm, preferably between 1.5 g/ccm and 3 g/ccm. A hot-melt adhesive film made of a polymer material such as, for example, a polyolefin or LD-PE is disposed between the heat reflection layer, which can be configured, for example, as a metallic foil made of aluminum with a thickness of typically between 50 and 500 micrometers, in particular between 75 and 150 micrometers, and the acoustic insulation layer.

In this case, the adhesive film forms a preferably plane but, at least in some areas, mechanical connection between the heat reflection layer and the insulation layer.

Such a heat shield can be manufactured simply and rationally even on a large scale, with a suitable production method being addressed in more detail below. Apart from very good thermal insulation properties, a heat shield according to the disclosure also has a significantly increased acoustic performance compared to the fully metallic heat shields known from the prior art. A series of rubber-elastic materials with densities in the specified range are known from the prior art, which have sufficient thermal stability in order to permit the use of a heat shield according to the disclosure over the entire life of a motor vehicle.

Is must be noted that, in connection with the present disclosure, a “heat shield for use on a motor vehicle” is understood to be a component that reduces the transfer of warmth and heat to a region of the motor vehicle to be shielded, e.g. the passenger compartment. In particular, a heat shield according to the disclosure may also be formed in such a way that it can be used as a so-called “water tank” for a motor vehicle. Such a “water tank” is a part of the end wall of a motor vehicle that separates the engine compartment from the passenger compartment and protects the latter from noise and heat immission from the engine compartment. In particular, such a “water tank” may include the construction space occupied by windshield wipers and spray nozzles.

It is particularly advantageous if the adhesive film, which may, for example, be heat-activatable, has at least partially thermosetting properties after activation. A variety of corresponding hot-melt adhesive films is known from the prior art. Adhesive films are available that can be heat-activated already at rather low temperatures, which may be, for example, between 120° C. and 130° C., i.e. that form a permanent and mechanically stress-resistant adhesive connection of the heat reflection layer and the insulation layer already at that temperature. In particular if the activated adhesive film has at least partially thermosetting properties, its thermal stress-resistance is significantly higher than its activation temperature. This means that, after its activation, a hot-melt adhesive film whose activation temperature is between 120° C. and 130° C., for example, withstands temperatures without any problems that are significantly higher than 150° C., in part even higher than 180° C., without liquefying again. The use of such hot-melt adhesive films in particular allows providing a permanent connection between the heat reflection layer and the insulation layer whose life can exceed the life of the motor vehicle on which the heat shield is used.

In an alternative embodiment, the hot-melt adhesive film comprises polymer ingredients that exhibit cross-linking reactions during heat-activation. Within the context of the present disclosure, such a hot-melt adhesive film can advantageously be used if it has a melting point that is increased after heat-activation by at least 30° C., preferably by at least 50° C. Also in the case of such a hot-melt adhesive film, it is true that it is able after its activation to withstand the temperatures arising in the thermoforming process without any problems without liquefying again (completely).

Finally, in another alternative embodiment, the hot-melt adhesive film melts in a thermoplastic manner at a temperature above its activation temperature without cross-linking, but even in the melted state provides sufficient adhesion between the heat reflection layer and the insulation layer if the material composite is introduced into the hot thermoforming tool. This may be realized, for example, by the material of the hot-melt adhesive film having a sufficiently high viscosity even in the melted state.

It is noted that, instead of a hot-melt adhesive film according to one of the above-described embodiments, a hot melt adhesive powder with comparable properties may, in principle, also be used.

Surprisingly, to the person skilled in the art, it was found that, even though many thermoplastic, rubber-elastic and thermoformable materials known from the prior art with a density in the claimed range have a melting temperature that is, in part, significantly below the temperatures occurring in a thermoforming process used for producing the heat shield, an interconnected material composite comprising a heat reflection layer, a hot-melt adhesive film and an insulation layer can nevertheless be prepared which withstands the high temperatures occurring for short periods of time during the thermoforming process used without disintegrating. The inventors attribute the cause this property of the heat shield according to the disclosure, which is surprising to the person skilled in the art, to the use of a hot-melt adhesive film with the above-described properties for gluing the heat reflection layer and the acoustic insulation layer together.

If the material of the acoustic insulation layer and the hot-melt adhesive film is suitably selected, it is also possible to provide a heat shield that has sufficient log-term resistance against the temperatures occurring on the heat shield during practical use, even if they should lie above the melting temperature of the acoustic insulation layer.

In an advantageous development, the acoustic insulation layer of the heat shield according to the disclosure comprises the rubber-elastic material in the form of a compacted granulated material. By means of suitable processing, a mat of defined density and defined thickness may, for example, be produced from such a granulated material, which in the state of being connected to the heat reflection layer by means a hot-melt adhesive film also withstands higher temperatures than the melting temperature of the thermoplastic rubber-elastic material of the acoustic insulation layer.

It was found to be particularly advantageous if the insulation layer includes an ethylene-propylene-diene rubber (hereinafter abbreviated as EPDM) as an ingredient. A percentage by weight of EPDM in the insulation layer between 20 and 50% is preferred, particularly preferably between 25 and 35%.

Further, it was found to be advantageous if the insulation layer, which may be based, for example, on EPDM, furthermore comprises a mineral filler, e.g. barium sulfate (BaSO₄) or dolomite. In principle, naturally occurring or synthetic silicates, carbonates, sulfates, oxides and hydroxides are suitable as fillers. The preferred percentage by weight of the mineral filler in the insulation layer in this case is between 55 and 85%, particularly preferably between 65 and 75%. By suitably selecting the mineral filler used and the added percentage by weight, the density of the acoustic insulation layer can be specifically adjusted.

Furthermore, it has proved to be advantageous if the insulation layer, which, also advantageously, may be based on EPDM, comprises as another component a certain proportion of HD-PE. A percentage by weight of HD-PE in the range between 2 and 10% was found to be preferred, particularly preferably between 3.5 and 6.5%. The addition of HD-PE in the specified range of percentage by weight results in a good relative adherence of the granular particles in the insulation layer, even at the increased temperatures occurring during the practical use of the heat shield according to the disclosure.

Another improvement of the acoustic effectiveness of a heat shield according to the disclosure may possibly also be obtained by introducing a micro-perforation into the heat reflection layer. To this end, circular holes, for example, with a diameter between 50 and 900 micrometers, preferably in a size range between 70 and 250 micrometers, and an area density of at least 15 holes per square centimeter are introduced into the heat reflection layer. In this case, the introduction of the holes may already take place during the production of the heat reflection layer. Optionally, however, they may also be introduced within the context of a manufacturing process for a heat shield according to the disclosure.

The application of a spherical-cup embossing onto the heat reflection layer can also improve the acoustic efficiency of a heat shield according to the disclosure, wherein it has proved particularly suitable if the spherical-cup embossing includes the introduction of a plurality of semi-spherical depressions into the heat reflection layer, whose diameter is in the range between 0.5 and 3 mm, in particular in the range between 1 and 1.5 mm. The density of the spherical cups is at least 100 spherical cups per dm², preferably 150 spherical cups per dm². Furthermore, the application of a spherical-cup embossing increases the rigidity of the heat reflection layer and thus imparts an increased mechanical stability to a heat shield according to the disclosure.

It was found in practical testing that the weight per unit area of a heat shield according to the disclosure advantageously is between 2 and 6 kg/sqm, particularly preferably between 3.5 and 5 kg/sqm. If the density of the acoustic insulation layer is in the specified range, typical thicknesses of a heat shield according to the disclosure of a few millimeters, typically between 2.5 and 5 mm, are obtained. Heat shields with such a thickness have a sufficient mechanical stability, so that deformations due to the influence of vibrations or the heat shield's own weight are not to be expected in practical operation even if heat shields with a large surface area are used.

It is noted that the features of the preferred developments can be freely combined with one another within the context of what is technically possible and feasible. Furthermore, the features discussed above in relation to advantageous developments of a heat shield according to the disclosure may of course be used in the context of the method of the disclosure for producing a heat shield described below. Such a method, which is suitable for producing a three-dimensionally contoured, acoustically effective heat shield for a motor vehicle, comprises the following method steps:
a) providing a two-dimensionally extending material composite comprising
   i) a heat reflection layer made of a metallic material, such as aluminum,
   ii) a heat-activatable hot-melt adhesive film made of a polymer material, such as a polyolefin or LD-PE, and
   iii) an acoustic insulation layer made of a thermoformable, thermoplastic and rubber-elastic material with a density between 1 g/ccm and 5 g/ccm, preferably between 1.5 g/ccm and 3 g/ccm, wherein the adhesive film is disposed between the heat reflection layer and the insulation layer,
b) thermoforming the two-dimensionally extending material composite in a thermoforming tool, in which at least one mold half has a molding tool temperature that is above the activation temperature of the heat-activatable hot-melt adhesive film and above the melting temperature of the thermoplastic rubber-elastic material of the insulation layer, for forming a three-dimensionally contoured heat shield.

In particular, the method according to the disclosure permits the production of heat shields according to the disclosure.

In a particularly advantageous embodiment of the method according to the disclosure, the molding tool temperature of at least one mold half is selected in such a way that the molding tool temperature is higher than the melting temperature of the acoustic insulation layer. In particular, the molding tool temperature is at least 10°, preferably at least 20°, and particularly preferably at least 30° higher than the melting temperature. If the rubber-elastic insulation layer is based on EPDM, the melting temperature of the insulation layer is in the range of about 130° C. Here, a processing temperature of the molding tool of about 180° C. has proved to be optimal.

Surprisingly, for the person skilled in the art, it was also found to be advantageous if the activation temperature of the adhesive film is also significantly lower than the temperature of the molding tool. It is possible, for example, to use an adhesive film based on polyolefin which has an activation temperature of about 130° C. Even at processing temperatures in the molding tool of 180° C., the material composite comprising a heat reflection layer, a hot-melt adhesive film and an insulation layer proves to be sufficiently mechanically connected, so that no delamination of the material composite or even a disintegration of the material composite would have to be expected, even during the shaping process in the heated molding tool.

Here, it was found that the adhesive connection of the material composite is particularly resistant against the increased temperatures during thermoforming, if the adhesive film, which is thermally activated, for example, has at least partially thermosetting properties after activation.

It was also found to be advantageous if the adhesive film after heat-activation has a melting point that is increased by at least 30° C., preferably by at least 50° C.

Finally, it was also found to be advantageous if the adhesive film melts at a temperature above its activation temperature, but even in the melted state provides an adhesion between the heat reflection layer and the insulation layer.

Within the context of the method according to the disclosure, the acoustic insulation layer can be formed in accordance with a method with the following method steps:
a) providing a rubber-elastic material in the form of a granulated material,
b) sprinkling the granulated material on a conveyor belt,
c) compacting and heating the granulated material beyond the melting point of the rubber-elastic material for setting the desired density and thickness of the insulation layer and for forming the insulation layer.

In method step c), the compacted granulated material is advantageously heated to a temperature that corresponds to at least the melting temperature of the rubber-elastic material used, but preferably is significantly higher than the melting temperature. The use of a temperature is particularly advantageous which is at least 10°, preferably at least 20° and particularly preferably at least 30° above the melting temperature of the rubber-elastic material used.

In a preferred development of the above-mentioned method for forming the insulation layer, the granulated material sprinkled onto a conveyor belt is brought together with the heat reflection layer and the hot-melt adhesive film prior to compacting and heating. Then, the material composite comprising the granulated material sprinkled onto the conveyor belt, the hot-melt adhesive film and the heat reflection layer is jointly subjected to the method step c), i.e. compacted and heated. When carrying out the process in this manner, it is particularly advantageous if the temperature used in method step c) is higher than the activation temperature of the hot-melt adhesive film.

In an alternative way of carrying out the process the insulation layer is manufactured by means of extrusion. A particularly simple way of carrying out the process is obtained particularly if the insulation layer is directly extruded onto the adhesive film, particularly preferably onto a two-dimensionally extending material composite comprising the adhesive film and the metallic heat reflection layer.

In a particularly advantageous development of the method according to the disclosure for forming the acoustic insulation layer, the material composite produced, which includes the metallic reflection layer, the hot-melt adhesive film and the extruded insulation layer, is subjected to a calendering step prior to the thermoforming carried out for forming the three-dimensionally contoured heat shield. This calendering step is carried out in such a way that an activation of the adhesive film occurs, so that a plane mechanical connection between the heat reflection layer and the insulation layer is formed.

With respect to preferred ingredients of the insulation layer and their advantageous percentages by weight, as well as with respect to advantageous embodiments of the metal foil used as a heat reflection layer, such as a possible micro-perforation or a possible spherical-cup embossing, reference is made to the statements connected with the heat shield according to the disclosure.

Advantageously, the method according to the disclosure, particularly with respect to the formation of the acoustically effective insulation layer, is carried out in such a manner that the weight per unit area of the material composite produced, and thus also of the heat shield obtained as the final product, is between 2 and 6 kg/sqm, particularly between 3.5 and 5 kg/sqm.

Furthermore, the method is carried out in such a way that the resulting thickness of the heat shield obtained as the final product is typically between 2.5 and 5 mm. In particular, the material composite comprising the metallic heat reflection layer, the hot-melt adhesive film and the acoustic insulation layer, which is delivered to the thermoforming process, may be in this thickness range.

### BRIEF DESCRIPTION OF THE DRAWINGS

Two exemplary embodiments for a method for producing heat shields according to the disclosure are discussed below. These exemplary embodiments are not to be understood as limiting but as examples, and are supposed to enable the person skilled in the art to carry out the method according to the disclosure. The exemplary embodiments will be explained with reference to the accompanying drawing. In the drawings:

FIG. 1 shows a schematic representation of a first exemplary embodiment of a method for producing blanks of a material composite comprising an acoustic insulation layer, a hot-melt adhesive film and a heat reflection layer,

FIG. 2 shows a schematic representation of a second exemplary embodiment of a method for producing blanks of a material composite comprising an acoustic insulation layer, a hot-melt adhesive film and a heat reflection layer,

FIG. 3 shows a schematic representation of a third exemplary embodiment of a method for producing blanks of a material composite comprising an acoustic insulation layer, a hot-melt adhesive film and a heat reflection layer,

FIGS. 4 and 5 show an exemplary embodiment for a method according to the disclosure,

FIG. 6 shows a schematic sectional view of a workpiece produced in accordance with the method according to FIGS. 4 and 5, and

FIG. 7 shows a schematic sectional view of a heat shield according to the disclosure produced in accordance with the method according to FIGS. 4 and 5.

### DETAILED DESCRIPTION OF THE DRAWINGS

FIG. 1 shows a first method for producing a two-dimensionally extending material composite 16 comprising a heat reflection layer 10 formed by an aluminum foil having a thickness of 100 micrometers, a heat-activatable hot-melt adhesive film 12 made of a thermoplastic polyolefin whose thickness is in the range of about 25 micrometers, and an acoustic insulation layer 14.

In this case, the material of the hot-melt adhesive film 12 exhibits a melting point increased by at least 30° C. after the heat-activation of the adhesive film 12, which is attributed to a polycondensation reaction in the material of the adhesive film 12.

The acoustic insulation layer 14 comprises at least the constituents EPDM with a percentage by weight of 20 to 30%, a mineral filler, such as, for example, barium sulfate with a percentage by weight of 70 to 80%, and PE-HD with a percentage by weight between 3.5 and 6.5%. In the exemplary embodiment shown, the filler content is 71% by wt. and the percentage by weight of PE-HD is 5%. The density of the acoustic insulation layer 14 is between 1.9 and 2 g/ccm, in the example shown 1.93 g/ccm. Despite the high percentage by weight of the mineral filler, the acoustic insulation layer 14 has rubber-elastic properties.

The insulation layer 14 is manufactured by the starting material with the above-described composition being sprinkled in a granulated form 18 onto a conveyor belt 20. Then, it is heated in a heating station 22 and then compacted to the desired thickness by two heated rollers 24. In the heating station 22, a temperature of the granulated material 18 is set which is above the melting temperature of the rubber-elastic material, which is approximately 130° C. in the exemplary embodiment discussed.

In a kind of sintering process, the compacting of the granulated material 18 heated beyond the melting point results in the formation of a continuous web 14 of EPDM with a defined thickness, which is set to 4 mm in the exemplary embodiment shown. The particles of the granulated material exhibit a good adhesion amongst each other due to the sintering process.

Then, the above-mentioned hot-melt adhesive film 12 and the aluminum foil 14 also mentioned above are delivered in a laminating station 26 to the still-hot web 14 of EPDM. In the laminating station 26, the combined material composite is pressurized by means of a roller, so that a mutually adhering material composite 16 is formed which includes the acoustic insulation layer 14, the hot-melt adhesive film 12 and the heat reflection layer 10 comprising aluminum foil. In the laminating station 26, use is made of the fact that the acoustic insulation layer 14 is still at a temperature close to the activation temperature of the hot-melt adhesive film 12. This results in a first adherence of the rubber-elastic acoustic insulation layer 14 to the aluminum foil 10 due to a partial melting of the hot-melt adhesive film 12. Optionally, this process may also be assisted by heating the pressure roller of the laminating station 26.

In a cutting station, fitting blanks are then cut to size from the material composite 16 produced in this way, which can then be delivered to further processing in a thermoforming process.

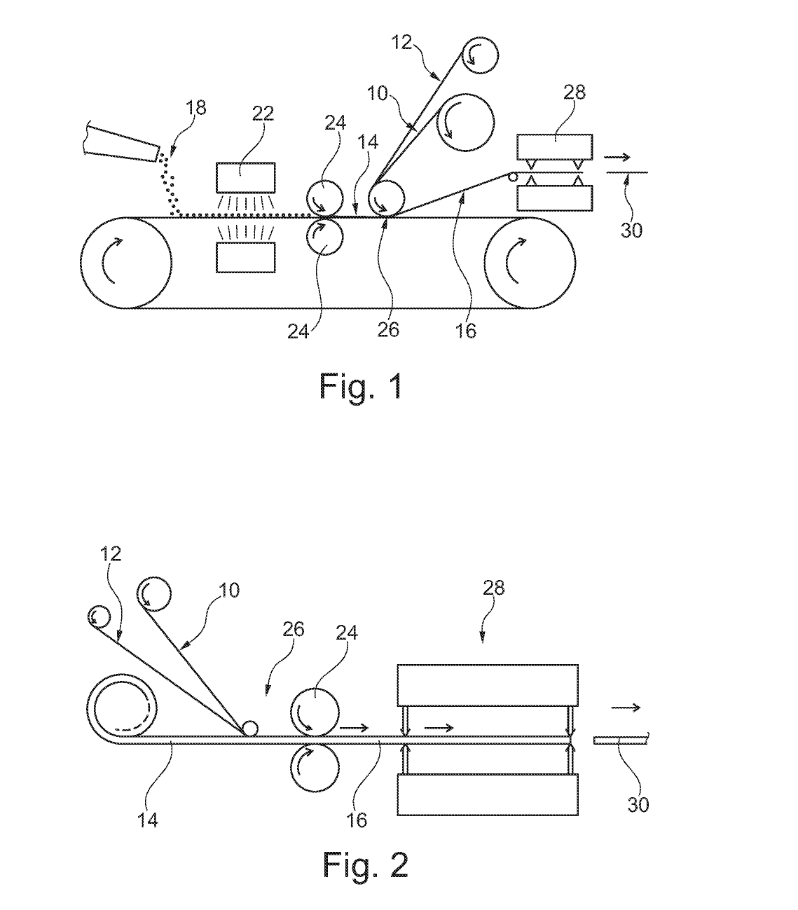

In an alternative way of carrying out the process shown in FIG. 2, the insulation layer 14 is already provided as a strip-shaped material which is located on a roll and has the desired thickness and density. The strip-shaped rubber-elastic material 14 is then fed into a laminating station 26 together with a hot-melt adhesive film 12 having the properties discussed above and an aluminum foil 10 having the properties discussed above. It it, the material composite 26 is heated by means of a heated pressure roller 24 to such an extent that at least a partial activation of the hot-melt adhesive film 12 is obtained, in such a way that the result is a sufficient adherence of the rubber-elastic acoustic insulation layer 14 to the aluminum foil 10. Also in this case, suitable blanks 30 are then cut to size from the strip-shaped material composite 16 in a cutting station 28, which can then be delivered to further processing in a thermoforming process.

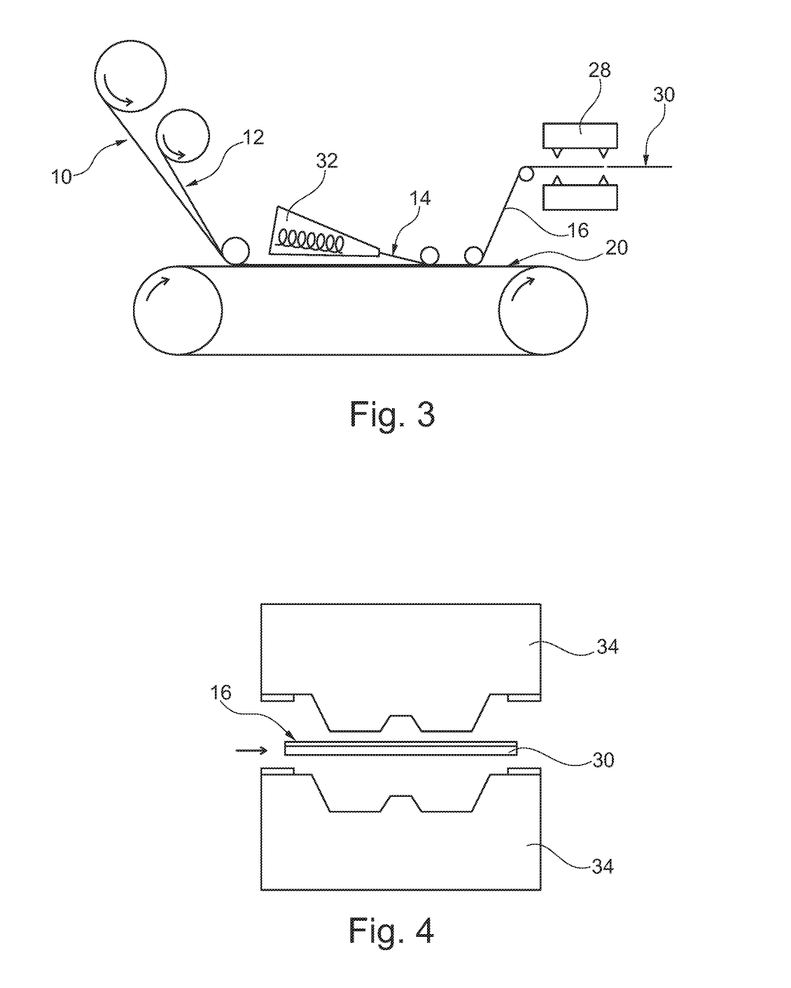

Finally, FIG. 3 shows another production method for the rubber-elastic insulation layer 14 and the material composite 16 comprising the insulation layer 14, the hot-melt adhesive film 12 and the heat reflection layer 10 comprising an aluminum foil. The heat reflection layer 10 configured as a metal foil is rolled up onto a roll and is brought together with a hot-melt adhesive film 12, which is also rolled up onto a roll, in a station suitable for this purpose.

Then, the rubber-elastic material of the acoustic insulation layer 14 is extruded in a strip-shape onto the surface of the material composite comprising the aluminum foil 10 and the hot-melt adhesive film 12 by means of a screw extruder 32. Since the rubber-elastic material of the insulation layer 14 has to be heated beyond its melting point for extrusion, the temperature of the insulation layer extruded onto the material composite comprising the aluminum foil 10 and the hot-melt adhesive film 12 can be set so as to result in at least a partial activation of the hot-melt adhesive film 12. This results in an adherence of the heat reflection foil 10 to the acoustic insulation layer 14 that is sufficient for further processing. If the material composite 16 produced in this way has cooled off to a sufficient extent, then fitting blanks 30 are again cut to size in a cutting station 28 for further processing.

The blanks 30 of the material composite 16 comprising the heat reflection layer 10, the hot-melt adhesive film 12 and the acoustic insulation layer 14 that were cut to size are then delivered to a thermoforming process, which is schematically explained with reference to the FIGS. 4 to 6.

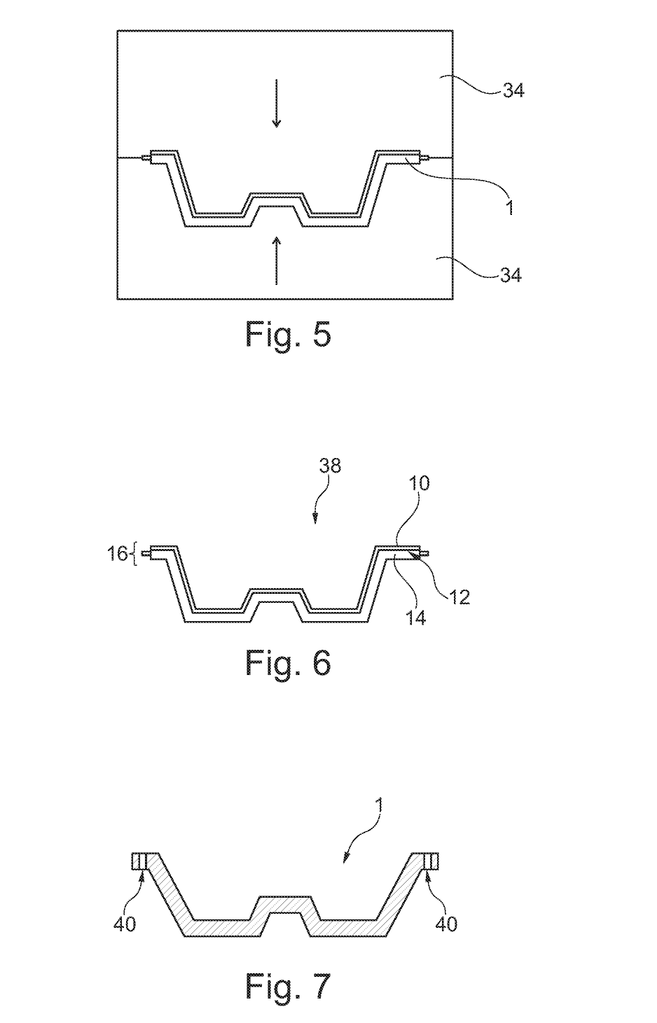

The thermoforming process is carried out by means of a molding tool 34 whose two halves 36 are configured to be heated. The tool temperature is set to about 180° C. for the thermoforming process. The blanks 30 of the material composite 16 that were cut to size are placed in the opened cavity of the molding tool 34 (see FIG. 4), whereupon the molding tool 34 is closed, as shown in FIG. 5. A suitable closing force is applied to the molding tool 34, which is then kept closed for a suitable period of time, which is typically between 20 and 200 seconds.

At 180° C., the temperature of the molding tool 34 is set to be significantly higher than the melting point of the acoustic insulation layer 14 of EPDM. As a consequence, the insulation layer 14 melts at least partially in the closed molding tool 34 and follows the three-dimensional contour embossed by the molding tool 34. At the same time, the hot-melt adhesive film 12 also fully completes its reaction in the closed molding tool 34. As a consequence, the high temperatures prevailing in the molding tool 34 no longer lead to a complete liquefaction of the hot-melt adhesive film 12, so that the result, even in the closed molding tool, is a sufficient adherence of the heat reflection layer 10 and the insulation layer 14. A disintegration of the material composite 16 in the molding tool 34 can be reliably avoided in this manner.

Then, the molding tool 34 is opened (not shown), and the workpiece 38, which is now provided with a three-dimensional contour, is removed from the molding tool 34 after cooling off for a short period of time. Finally, the three-dimensionally contoured workpiece shown schematically in a sectional view in FIG. 6 is conveyed to a cutting station (not shown) in which a peripheral cutting process is performed. Optionally, holes 40 are punched out subsequently or in parallel, e.g. in order to form assembly openings in the heat shield 1, which is thus finished and shown in FIG. 7 also in a schematic sectional view.

An advanced way of carrying out the process provides that the molding tool 34 is additionally provided with cutting or punching tools in order to realize the blanking of the produced workpiece 38 and the placement of the desired punched-out holes 40 in parallel with the thermoforming process.

1. A three-dimensionally contoured, acoustically effective heat shield for a motor vehicle, comprising:
a) a heat reflection layer made of a metallic material, such as aluminum,
b) an acoustic insulation layer made of a thermoformable, rubber-elastic and thermoplastic material with a density between 1 g/ccm and 5 g/ccm, and
c) a hot-melt adhesive film made of a polymer material, such as a polyolefin or LD-PE, wherein the adhesive film is disposed between the heat reflection layer and the insulation layer and forms a plane mechanical connection between the heat reflection layer and the insulation layer.

2. The heat shield according to claim 1, wherein the insulation layer includes the thermoformable, rubber-elastic, thermoplastic material in the form of a compacted granulated material.

3. The heat shield according to claim 1, wherein the hot-melt adhesive film is heat-activatable and, after heat-activation, has a melting point that is increased by at least 30° C.

4. The heat shield according to claim 1, wherein the hot-melt adhesive film is heat-activatable and, after heat-activation, has at least partially thermosetting properties.

5. The heat shield according to claim 1, wherein the hot-melt adhesive film melts at a temperature above its activation temperature, but even in the melted state provides an adhesion between the heat reflection layer and the insulation layer.

6. The heat shield according to claim 3, wherein the insulation layer has a melting temperature that is comparable with the activation temperature of the hot-melt adhesive film.

7. The heat shield according to claim 1, wherein the insulation layer includes EPDM in a percentage by weight between 20% and 50%.

8. The heat shield according to claim 1, wherein the insulation layer includes a mineral filler in a percentage by weight between 55% and 85%.

9. The heat shield according to claim 1, wherein the insulation layer includes HD-PE in a percentage by weight between 2% and 10%.

10. The heat shield according to claim 1, wherein the heat reflection layer includes a metal foil whose thickness is between 50 and 250 micrometers.

11. The heat shield according to claim 1, wherein the heat reflection layer is micro-perforated or has a spherical-cup embossing.

12. The heat shield according to claim 1, wherein the weight per unit area of the two-dimensionally extending material composite comprising the heat reflection layer, the hot-melt adhesive film and the insulation layer is between 2 and 6 kg/sqm.

13. A method for producing a three-dimensionally contoured, acoustically effective heat shield for a motor vehicle, including the steps of:
a) providing a two-dimensionally extending material composite comprising
i) a heat reflection layer made of a metallic material, such as aluminum,
ii) a heat-activatable hot-melt adhesive film made of a polymer material, such as a polyolefin or LD-PE, and
iii) an acoustic insulation layer made of a thermoformable, rubber-elastic, thermoplastic material with a density between 1 g/ccm and 5 g/ccm, wherein the adhesive film is disposed between the heat reflection layer and the insulation layer,
b) thermoforming the two-dimensionally extending material composite in a thermoforming tool, in which at least one mold half has a molding tool temperature that is above the activation temperature of the heat-activatable adhesive film and above the melting temperature of the rubber-elastic material of the insulation layer, for forming a three-dimensionally contoured heat shield.

14. The method according to claim 13, wherein the insulation layer is formed by the following method steps:
a) providing a rubber-elastic material in the form of a granulated material,
b) sprinkling the granulated material on a conveyor belt,
c) compacting and heating the granulated material beyond the melting point of the rubber-elastic material for setting the desired density and thickness of the insulation layer and for forming the insulation layer.

15. The method according to claim 14, wherein the heat reflection layer and the hot-melt adhesive film are fed to the conveyor belt prior to the method step c) in such a way that the heat reflection layer and the hot-melt adhesive film are also subjected to the method step c).

16. The method according to claim 15, wherein in method step c), the temperature of the heated granulated material is higher than the activation temperature of the hot-melt adhesive film.

17. The method according to claim 13, wherein the insulation layer is produced by means of extrusion.

18. The method according to claim 17, wherein the insulation layer is extruded onto the hot-melt adhesive film, onto a two-dimensionally extending material composite comprising the heat reflection layer and the hot-melt adhesive film.

19. The method according to claim 18, wherein the material composite is calendered prior to thermoforming in such a way that an at least partial activation of the adhesive film occurs so that a plane mechanical connection between the heat reflection layer and the insulation layer is formed.

20. The method according to claim 13, wherein the adhesive film, after heat-activation, has a melting point that is increased by at least 30° C.

21. The method according to claim 13, wherein the adhesive film, after heat-activation, has at least partially thermosetting properties.

22. The method according to claim 13, wherein the adhesive film melts at a temperature above its activation temperature, but even in the melted state provides an adhesion between the heat reflection layer and the insulation layer.

23. The method according to claim 13, wherein the insulation layer has a melting temperature, and the molding tool temperature is higher than the melting temperature, in particular at least 10° C. higher than the melting temperature.

24. The method according to claim 13, wherein the insulation layer includes EPDM in a percentage by weight between 20% and 50%.

25. The method according to claim 13, wherein the insulation layer includes a mineral filler in a percentage by weight between 55% and 85%.

26. The method according to claim 13, wherein the insulation layer includes HD-PE in a percentage by weight between 2% and 10%.

27. The method according to claim 13, wherein the heat reflection layer includes a metal foil whose thickness is between 50 and 250 micrometers.

28. The method according to claim 13, wherein the heat reflection layer is micro-perforated or has a spherical-cup embossing.

29. The method according to claim 13, wherein the weight per unit area of the two-dimensionally extending material composite is between 2 and 6 kg/sqm.
